(19) United States
(12) Patent Application Publication
(10) Pub. No.: US 2026/0304495 A1
(43) Pub. Date: Oct. 1, 2026

(54) EARLY BANDWIDTH ADAPTATION FOR INITIAL ACCESS

(71) Applicant: QUALCOMM Incorporated, San Diego, CA (US)

(72) Inventors: Yan ZHOU, San Diego, CA (US); In-Soo KIM, San Diego, CA (US); Jing JIANG, San Diego, CA (US)

(21) Appl. No.: 19/632,100

(22) Filed: Mar. 27, 2026

Related U.S. Application Data
(60) Provisional application No. 63/780,099, filed on Mar. 28, 2025.

(51) Int. Cl. H04W 74/0833; H04W 36/00

(52) U.S. Cl. CPC H04W 74/0833; H04W 36/00692

(57) ABSTRACT

Apparatus, methods, and computer program products for wireless communication are provided. An example method may include transmitting, to a network node, a first random access channel (RACH) message that indicates an update associated with an initial bandwidth part (BWP), where the first RACH message is associated with a RACH procedure. The example method may further include receiving, from the network node in response to the first RACH before a completion of the RACH procedure, a second RACH message that indicates an updated BWP.

### CROSS REFERENCE TO RELATED APPLICATION(S)

The present Application for Patent claims priority under 35 U.S.C. § 119 to U.S. Provisional Patent Application No. 63/780,099, filed Mar. 28, 2025 and entitled “Early Bandwidth Adaptation for Initial Access,” which is assigned to the assignee hereof and hereby expressly incorporated by reference herein in its entirety.

### TECHNICAL FIELD

The present disclosure relates generally to communication systems, and more particularly, to wireless communication systems with random access channel (RACH).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may include at least one memory and at least one processor coupled to the at least one memory. Based at least in part on information stored in the at least one memory, the at least one processor, individually or in any combination, is configured to (e.g., cause the UE to) transmit, to a network node, a first random access channel (RACH) message that indicates an update associated with an initial bandwidth part (BWP), where the first RACH message is associated with a RACH procedure. Based at least in part on information stored in the at least one memory, the at least one processor, individually or in any combination, is configured to receive, from the network node in response to the first RACH before a completion of the RACH procedure, a second RACH message that indicates an updated BWP.

In another aspect of the disclosure, a method, a computer-readable medium, and an apparatus at a network entity are provided. The apparatus may include at least one memory and at least one processor coupled to the at least one memory. Based at least in part on information stored in the at least one memory, the at least one processor, individually or in any combination, is configured to receive a first random access channel (RACH) message that indicates an update associated with an initial bandwidth part (BWP), where the first RACH message is associated with a RACH procedure of a user equipment (UE). Based at least in part on information stored in the at least one memory, the at least one processor, individually or in any combination, is configured to transmit, for the UE before a completion of the RACH procedure, a second RACH message that indicates an updated BWP in response to the first RACH.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network, in accordance with various aspects of the present disclosure.

FIG. 4A and FIG. 4B illustrate example aspects of random access, in accordance with various aspects of the present disclosure.

FIG. 5 is a diagram illustrating example communications between a network node and a UE, in accordance with various aspects of the present disclosure.

FIG. 6 is a diagram illustrating example communications between a network node and a UE, in accordance with various aspects of the present disclosure.

FIG. 7 is a diagram illustrating example adaptation from an initial bandwidth part (BWP) to an updated BWP, in accordance with various aspects of the present disclosure.

FIG. 8 is a diagram illustrating an example timeline associated with bandwidth (BW) adaptation, in accordance with various aspects of the present disclosure.

FIG. 9 is a diagram illustrating an example timeline associated with BW adaptation, in accordance with various aspects of the present disclosure.

FIG. 10 is a diagram illustrating an example timeline associated with BW adaptation, in accordance with various aspects of the present disclosure.

FIG. 11 is a diagram illustrating an example timeline associated with BW adaptation, in accordance with various aspects of the present disclosure.

FIG. 12 is a diagram illustrating an example timeline associated with BW adaptation, in accordance with various aspects of the present disclosure.

FIG. 13 is a flowchart of a method of wireless communication, in accordance with various aspects of the present disclosure.

FIG. 14 is a flowchart of a method of wireless communication, in accordance with various aspects of the present disclosure.

FIG. 15 is a diagram illustrating an example of a hardware implementation for an example apparatus and/or network entity, in accordance with various aspects of the present disclosure.

FIG. 16 is a diagram illustrating an example of a hardware implementation for an example network entity, in accordance with various aspects of the present disclosure.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Regardless of the specific method used for adapting bandwidth, in some wireless communication systems, the bandwidth may be adapted for the user equipment (UE) after the UE completes random access channel (RACH) and completes registration to the core network. For example, the BW of an initial BWP may be small (for example, 24 to 96 RBs, corresponding to 10 and 35 MHz BW, respectively, for 30 kHz SCS), and the initial active DL/UL BWP may be confined within a UE minimum BW for a given frequency band. In some wireless communication systems, the BW may be adapted based on a UE specific BWP configuration, where once the UE completes registration to core network, the network node, via a RRC reconfiguration message, may provide UE-specific DL/UL BWP configurations. In some wireless communication systems, the BW may be adapted based on a UE specific carrier aggregation (CA) or dual connectivity (DC) configuration, where once the UE completes registration to core network, the network node may, via RRC reconfiguration message, provide UE specific CA/DC configuration based on the UE's CA/DC capabilities. However, for some UEs (for example, idle UEs at a cell edge or other UE that may have a poor link quality with the network node), larger bandwidth may improve initial access performance by providing better coverage, reliability, and throughput, which may not be available if the UE cannot adapt bandwidth before the UE completes RACH and completes registration to core network. For example, DL broadcast PDCCH/PDSCH may be one coverage bottleneck in certain frequency bands. The network node may have a constant power spectral density (PSD) in the DL and more BW may provide more energy, frequency diversity gain, and throughput. However, larger BW, achieved by either UE-specific BWP or CA, may be configured via RRC reconfiguration after an authentication and security process, which may involve multiple packet exchanges. Aspects provided herein enable a UE to adapt its bandwidth before completion of the RACH procedure to potentially improve initial access performance by providing better coverage, reliability, and throughput. For example, the network node may provide indication of early BW adaptation before completion of the RACH procedure (for example, as early as the first DL message during RACH) to improve coverage, reliability, and throughput for the remaining messages until RRC reconfiguration finishes. In some aspects, the BW may be increased (for example, from 5 to 40 MHz for sub 1 GHz FDD band). In some aspects, the BW may be decreased to save power at the UE in absence of high traffic demand. In some aspects, early BW adaptation may include switch of BW related parameters, BWP, carrier/cell, or CA/DC configuration.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof. One or more processors in the processing system may execute software to cause a device that includes the one or more processors to perform the various functionality described throughout this disclosure.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer (e.g., transitory or non-transitory medium that may be accessed by computer).

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

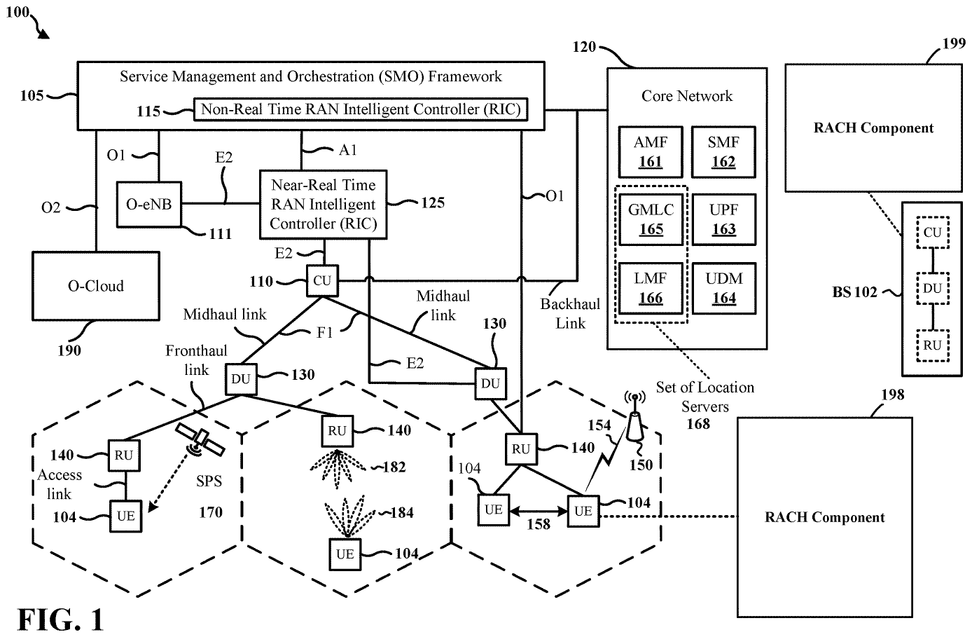

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHZ), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a RACH component 198. In some aspects, the RACH component 198 may be configured to transmit, to a network node, a first random access channel (RACH) message that indicates an update associated with an initial bandwidth part (BWP), where the first RACH message is associated with a RACH procedure. In some aspects, the RACH component 198 may be further configured to receive, from the network node in response to the first RACH before a completion of the RACH procedure, a second RACH message that indicates an updated BWP.

In certain aspects, the base station 102 may include a RACH component 199. In some aspects, the RACH component 199 may be configured to receive a first random access channel (RACH) message that indicates an update associated with an initial bandwidth part (BWP), where the first RACH message is associated with a RACH procedure of a user equipment (UE). In some aspects, the RACH component 199 may be further configured to transmit, for the UE before a completion of the RACH procedure, a second RACH message that indicates an updated BWP in response to the first RACH.

Although the following description may be focused on 5G NR, the concepts described herein may be applicable to other similar areas, such as 6G, LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

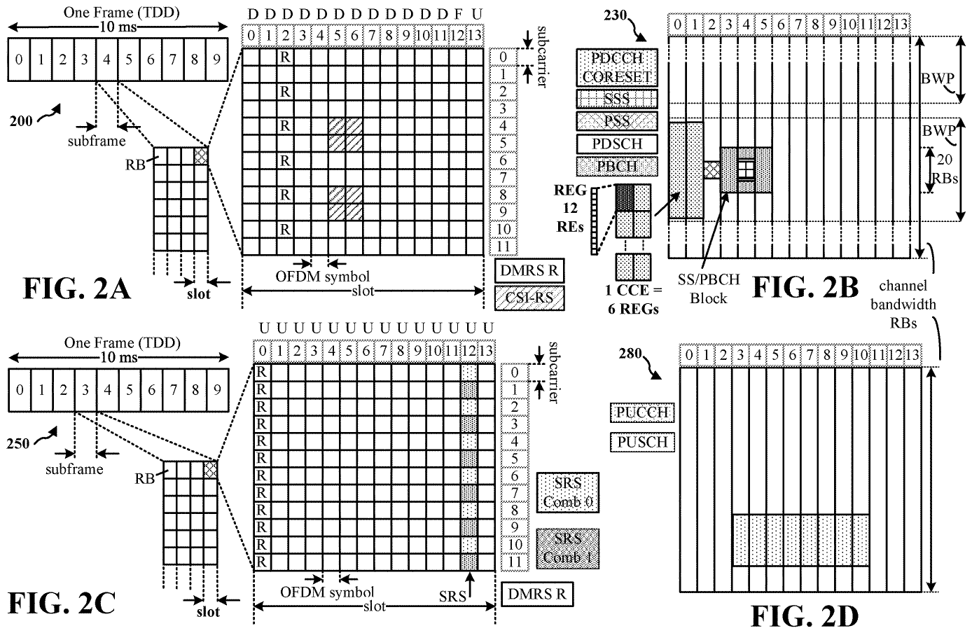

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}* 15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages. In some aspects, the term “PDXCH” may refer to either PDCCH or PDSCH.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

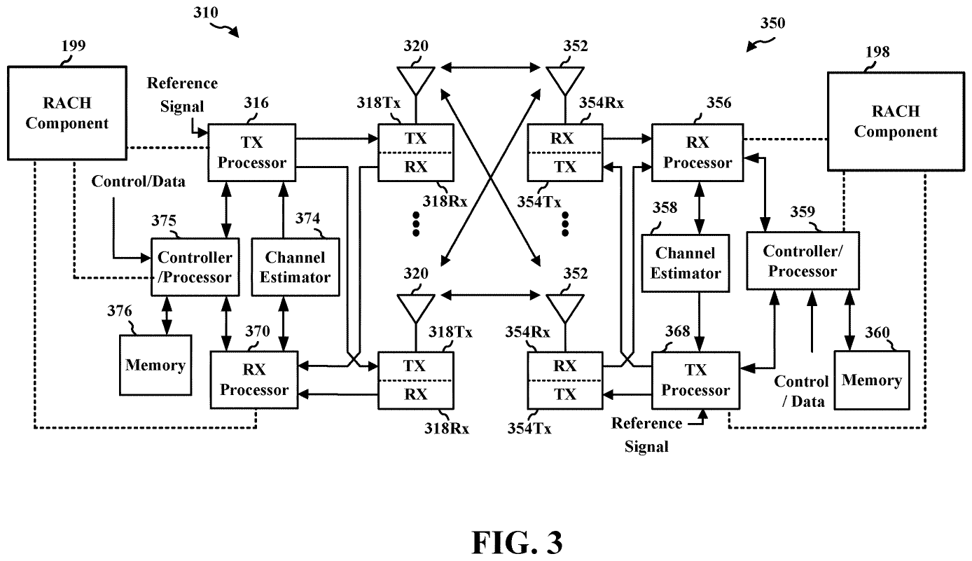

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recovery any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recovery the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recovery IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recovery IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with RACH component 198 of FIG. 1.

At least one of the TX processor 316, the RX processor 370, and the controller/processor 375 may be configured to perform aspects in connection with RACH component 199 of FIG. 1.

A UE may use a random access procedure in order to communicate with a network node. For example, the UE may use the random access procedure for various reasons, e.g., including to request an RRC connection, to re-establish an RRC connection, resume an RRC connection, etc. Random access procedures may include two different random access procedures, e.g., The UE may use contention based random access (CBRA) may be performed when a UE is not synchronized with a network node, and contention free random access (CFRA) may be applied, e.g., when the UE was previously synchronized to a network node. Both the procedures include transmission of a random access preamble from the UE to the network node. In CBRA, a UE may randomly select a random access preamble sequence, e.g., from a set of preamble sequences. As the UE randomly selects the preamble sequence, the network node may receive another preamble from a different UE at the same time. Thus, CBRA provides for the network node to resolve such contention among multiple UEs. In CFRA, the network may allocate a preamble sequence to the UE rather than the UE randomly selecting a preamble sequence. This may help to avoid potential collisions with a preamble from another UE using the same sequence. Thus, CFRA is referred to as “contention free” random access. The preamble may be based on a particular preamble format, such as long format for large cell coverage, short format for dense urban areas, or the like.

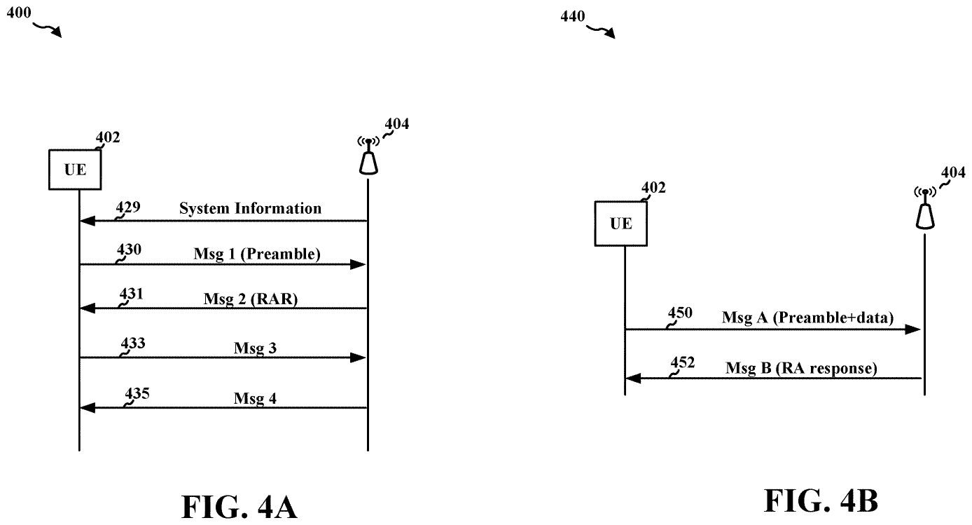

FIG. 4A illustrates example aspects of a random access procedure 400 between a UE 402 and a network node such as a network node 404. The aspects illustrated for the network node 404 may be performed by one or more components of the network node. The UE 402 may initiate the random access message exchange by sending, to the network node 404, a first random access message 430 (e.g., message 1 or Msg 1) including a preamble in a random access occasion (RO). Prior to sending the first random access message 430, the UE may obtain random access parameters, e.g., including preamble format parameters, time and frequency resources, parameters for determining root sequences and/or cyclic shifts for a random access preamble, etc., e.g., in system information 429 from the network node 404. The preamble may be transmitted with an identifier, such as a random access RNTI (RA-RNTI). The UE 402 may randomly select a random access preamble sequence, e.g., from a set of preamble sequences. If the UE 402 randomly selects the preamble sequence, the network node 404 may receive another preamble from a different UE at the same time. In some examples, a preamble sequence may be assigned to the UE 402.

The network node responds to the first random access message 430 by sending a second random access message 431 (e.g., Msg 2) using PDSCH and including a random access response (RAR). The RAR may include, e.g., an identifier of the random access preamble sent by the UE, a time advance (TA), an uplink grant for the UE to transmit data, cell radio network temporary identifier (C-RNTI) or another identifier, and/or a back-off indicator. Upon receiving the second random access message 431, the UE 402 may transmit a third random access message 433 (e.g., Msg 3) to the network node 404, e.g., using PUSCH, that may include a RRC request, such as a RRC connection request, an RRC connection re-establishment request, or an RRC connection resume request, depending on the trigger for the initiating the random access procedure. The network node 404 may then complete the random access procedure by sending a fourth random access message 435 (e.g., Msg 4) to the UE 402, e.g., using PDCCH for scheduling and PDSCH for the message. The fourth random access message 435 may include a random access response message that includes timing advancement information, contention resolution information, and/or RRC connection setup information. The UE 402 may monitor for PDCCH, e.g., with the C-RNTI. If the PDCCH is successfully decoded, the UE 402 may also decode PDSCH. The UE 402 may send HARQ feedback for any data carried in the fourth random access message. If two UEs sent a same preamble at 430, both UEs may receive the RAR leading both UEs to send a third random access message 433. The network node 404 may resolve such a collision by being able to decode the third random access message from one of the UEs and responding with a fourth random access message to that UE. The other UE, which did not receive the fourth random access message 435, may determine that random access did not succeed and may re-attempt random access. Thus, the fourth message may be referred to as a contention resolution message. The fourth random access message 435 may complete the random access procedure. Thus, the UE 402 may then transmit uplink communication and/or receive downlink communication with the network node 404 based on the second random access message 431 and/or the fourth random access message 435.

In order to reduce latency or control signaling overhead, a single round trip cycle between the UE 402 and the network node 404 may be achieved in a 2-step RACH process, as shown in the communication flow 440 in FIG. 4B. Aspects of Msg 1 and Msg 3 may be combined in a single message, e.g., which may be referred to as Msg A 450 (message A or Msg A). The Msg A may include a random access preamble, and may also include a PUSCH transmission, e.g., such as data. The Msg A preambles may be separate from the four step preambles, yet may be transmitted in the same ROs as the preambles of the four step RACH procedure or may be transmitted in separate ROs. The PUSCH transmissions may be transmitted in PUSCH occasions (POs) that may span multiple symbols and PRBs. After the UE 402 transmits the Msg A 450, the UE 402 may wait for a response from the network node 404. Additionally, aspects of the Msg 2 and Msg 4 may be combined into a single message, which may be referred to as Msg B 452 (message B or Msg B).

A RACH procedure (e.g., which may also be referred to as a random access procedure) may be used for acquiring a connection to a cell, as well as part of various connection mode procedures. A RACH procedure can be 4-step or 2-step, e.g., as illustrated in FIG. 4A and FIG. 4B. A RACH procedure may be based on a contention based procedure or a contention free procedure, e.g., depending on the timing advance (TA) information available. A RACH procedure may facilitate obtaining the accurate TA and/or cell random network temporary identifier (C-RNTI) for a UE to exchange connected mode communication with the network. An SSB may provide the details of the time offset at which RACH procedure can be initiated with message 1 transmission in UL, for example. Based on the message 1, which may include a Zadoff Chu sequence, and autocorrelation output, the network may estimate an adjustment to TA and inform the UE of the adjustment to the TA as part of message 2. The UE may adjust the TA as part of preparing to transmit a message. The UE may then transmit the RRC Connection Request (e.g., message 3) to the network along with a randomly generated number as temporary C-RNTI (TC-RNTI). The network may reply by sending the contention resolution message (message 4) along with TC-RNTI received in message 3. When the received message 4 TC-RNTI matches with message 3 TC-RNTI sent from the UE, the RACH procedure may be assumed to be successful and TC-RNTI may be noted as C-RNTI for further connection mode procedures. Otherwise, the UE may determine that the RACH procedure has failed. A RACH procedure may also be used for various activities, such as beam failure recovery (BFR), scheduling request (SR) failure, TA calculation, during out of service (OOS) recovery, handover, or the like. In some aspects, a 4-step RACH may be based on CBRA and a 2-step RACH may be based on a CFRA procedure. When target cell SSB information is available from source cell, a UE may use the 2-step RACH procedure for faster acquisition as part of a CFRA procedure. In some wireless communication systems, various RACH parameters such as initial preamble power, quantity of retransmissions allowed, power ramp up step between retransmission, scaling factor, contention resolution timer, RACH response window, and other parameters, may be indicated by the network, e.g., as part of a configuration, and followed by the UE for RACH procedure.

The bandwidth (BW) of an initial BWP may be small, such as 24 to 96 RBs, corresponding to 10 and 35 MHz BW, respectively, for 30k SCS. The initial active DL/UL BWP may be confined within a UE minimum BW for a given frequency band. In some wireless communication systems, there may be mechanisms for updating the BW to be different from that for initial BWP after the UE completes registration to the core network. For example, the BW may be adapted based on a UE specific BWP configuration (e.g., represented by information element (IE) UE specific BWP configuration). Once UE completes registration to core network, the network node, via a RRC reconfiguration message, may provide UE-specific DL/UL BWP configurations via a parameter that indicates dedicated DL BWP (e.g., BWP-DownlinkDedicated) and a parameter that indicates dedicated UL BWP (e.g., BWP-UplinkDedicated). In such configurations, the maximum BW per BWP may be configured based on UE channel BW capability per band per SCS. The maximum BWP quantity and switching method may be configured based on UE BWP related capabilities. As another example, the BW may be adapted based on a UE specific configurations. Once UE completes registration to core network, the network node may, via RRC reconfiguration message, provide UE specific carrier aggregation (CA) or dual connectivity (DC) CA/DC configuration via a cell group configuration (e.g., represented by IE CellGroupConfig) for master cell group (MCG) or secondary cell group (SCG) based on the UE's CA/DC capabilities. Regardless of the specific method used for adapting bandwidth, in some wireless communication systems, the bandwidth may be adapted for the UE after the UE completes RACH and completes registration to the core network. However, for some UEs (e.g., idle UEs at a cell edge or other UE that may have a poor link quality with the network node), larger bandwidth may improve initial access performance by providing better coverage, reliability, and throughput, which may not be available if the UE cannot adapt bandwidth before the UE completes RACH and completes registration to core network. Aspects provided herein enables a UE to adapt its bandwidth before completion of the RACH procedure to potentially improve initial access performance by providing better coverage, reliability, and throughput. In addition to adapting to a larger BW, adapting to a smaller BW may also be possible to save power at the UE. As an example, the network node may have a constant power spectral density (PSD) in the downlink and more BW may provide more energy, frequency diversity gain, and/or throughput. If larger BW, achieved by either UE-specific BWP or CA, may be configured via RRC reconfiguration after an authentication and security process but not before, the performance before completion of the authentication and security process may be improved by aspects herein. In some aspects, the network node may provide indication of “early BW adaptation” or “BW adaptation” before completion of the RACH procedure (e.g., as early as the first DL message during RACH) to improve coverage, reliability, throughput for the remaining messages, e.g., until RRC reconfiguration finishes. For example, the BW may be increased from 5 to 40 MHz for sub 1 GHz FDD band n28. Early BW adaptation may include switch of BW related parameters, BWP, carrier/cell, or CA/DC configuration.

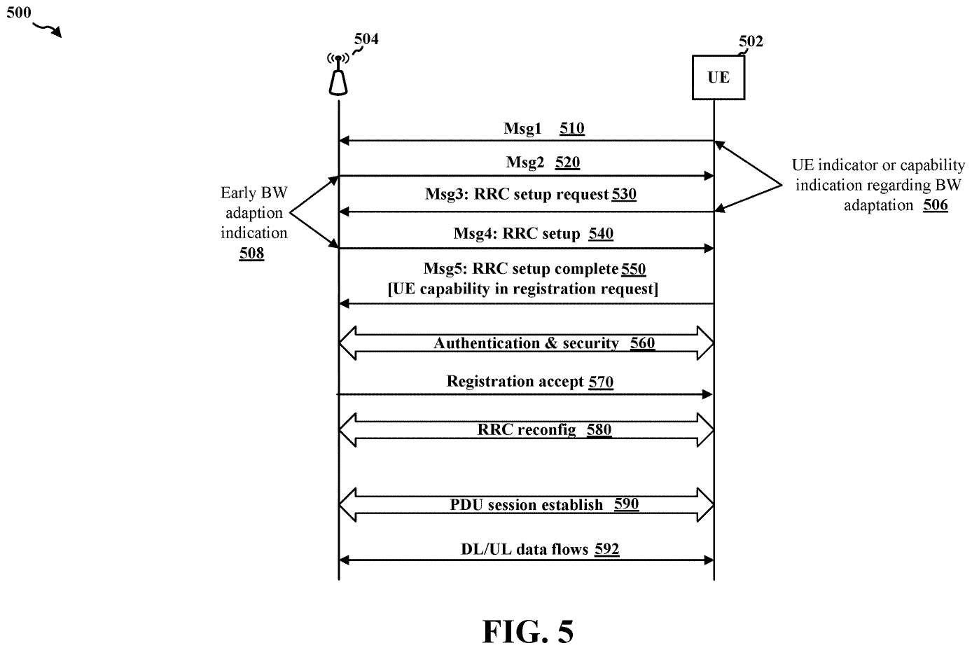

FIG. 5 is a diagram 500 illustrating example communications between a network node 504 and a UE 502, in accordance with various aspects of the present disclosure. As illustrated in FIG. 5, the UE 502 may transmit a message 1 510 to the network node 504 (e.g., based on broadcasted system information) and receive a message 2 520 in response to the message 1. The UE may further transmit a message 3 530 to the network node 504 and receive a message 4 540 in response. In some aspects, the network node 504 may include an early BW adaptation indication 508 in the message 2 520, the message 4 540, or a message 6 (not shown) after message 4 but before completion of authentication and security 560 to indicate updating an initial BWP to an updated BWP for the UE 502. In some aspects, inclusion of the early BW adaptation indication 508 may be based on an UE indicator associated with the early BW adaptation (e.g., such as an implicit or explicit UE indication) or a UE capability indication 506 associated the UE 502, which may be included in message 1 510, message 3 530, or message 5 550 (which may indicate a completion of the RRC set-up).

After authentication and security 560, there may be a registration accept message 570 transmitted from the network node 504 to the UE 502, a RRC reconfiguration at 580, PDU session establishment at 590, and DL or UL data flows at 592. By using the early BW adaptation indication 508, the UE 502 may be able to change its BW before the RRC reconfiguration at 580.

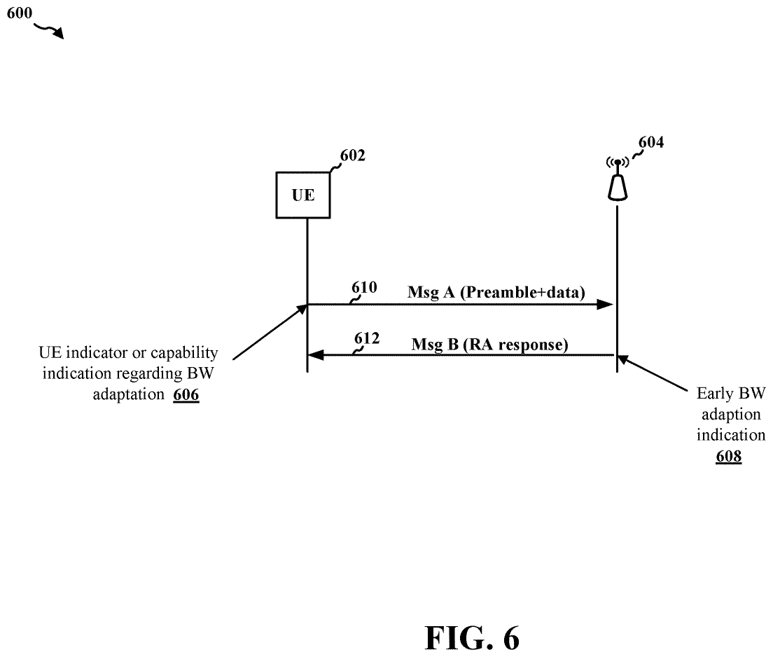

FIG. 6 is a diagram 600 illustrating example communications between a network node 604 and a UE 602, in accordance with various aspects of the present disclosure. As illustrated in FIG. 6, the UE 602 may transmit a message A 610 to the network node 604, and receive a message B 612 in response. In some aspects, the network node 604 may include an early BW adaptation indication 608 in the message B 612 to indicate updating an initial BWP to an updated BWP for the UE 602. In some aspects, inclusion of the early BW adaptation indication 608 may be based on an UE indicator associated with the early BW adaptation (e.g., such as an implicit or explicit UE indication) or a UE capability indication 606 associated with the UE 602, which may be included in message A 610. By enabling the network node to include the early BW adaptation indication in message B based on UE indicator or capability indication, the 2-step RACH procedure may benefit from reduced latency in achieving improved coverage, reliability, and throughput compared to waiting until RRC reconfiguration, as the UE may adapt its BW as early as the first DL message during initial access.

In some aspects, the early BW adaptation indication 508 or the early BW adaptation indication 608 may indicate: (1) switch of BW parameters for the same BWP (e.g., to update the initial BWP to the updated BWP, the set of BW parameters for the initial DL or UL BWP is switched to another candidate parameter set), (2) switch of BWP (e.g., to update the initial BWP to the updated BWP, the initial DL or UL BWP is switched to another candidate DL or UL BWP), (3) switch of carrier/cell (e.g., to update the initial BWP to the updated BWP, the initial carrier/cell is switched to another candidate carrier/cell for the UE to continue initial access), or (4) switch of CA/DC configuration (e.g., to update the initial BWP to the updated BWP, the initial cell or CA/DC configuration is switched to another candidate CA/DC configuration for the UE to continue initial access). By providing multiple cases for early BW adaptation (switch of BW parameters, switch of BWP, switch of carrier/cell, or switch of CA/DC configuration), the network node may flexibly select an appropriate adaptation mechanism based on UE capability and network conditions, which may improve initial access performance by providing better coverage, reliability, and throughput through increased energy, frequency diversity gain, or aggregated bandwidth.

To facilitate the update, there may be multiple candidate DL and UL BW parameter sets may be configured or defined (e.g., in SIB 1 or another SIB) that may be used for updating the BWP. In some aspects, each candidate DL or UL BW parameter set of the multiple candidate DL and UL BW parameter sets may be a candidate BW parameter set that may be potentially selected for the update of the same logic initial DL or UL BWP. In some aspects, each candidate DL or UL BW parameter set of the multiple candidate DL and UL BW parameter sets may be a candidate DL or UL BWP that may be potentially selected for the update of the same logic initial DL or UL BWP to replace the initial DL or UL BWP. In some aspects, each candidate DL or UL BW parameter set of the multiple candidate DL and UL BW parameter sets may be a candidate cell that may be potentially selected for the update of the same logic initial DL or UL BWP to replace an initial cell. In some aspects, each candidate DL or UL BW parameter set of the multiple candidate DL and UL BW parameter sets may be a CC in a candidate CA/DC configuration that may be potentially selected for the update of the same logic initial DL or UL BWP to replace an initial CA/DC configuration. In some aspects, the early BW adaptation indication may carry the candidate DL or UL BW parameter set ID(s) or directly carry detailed parameters. By pre-configuring multiple candidate DL and UL BW parameter sets (for example, in SIB 1 or another SIB), the signaling overhead for early BW adaptation indication may be reduced, as the indication may carry candidate BW parameter set ID(s) rather than detailed parameters, which may facilitate faster BW adaptation during initial access and improve coverage, reliability, and throughput for the remaining messages.

In some aspects, the network node may configure or there may be configuration without signaling that may provide the configuration or rule to determine the parameters per candidate DL BW parameter set for the early DL BW adaptation. As an example, the configuration may be broadcast in MIB or SIB1. By broadcasting the configuration for candidate DL BW parameter sets in MIB or SIB1, the UE may obtain the configuration prior to initiating the RACH procedure, which may reduce signaling overhead during initial access and enable faster BW adaptation to improve coverage, reliability, and throughput.

In some aspects, the parameters per candidate DL BW parameter set that may be configured for updating the initial BWP to the updated BWP may include carrier parameters independent of SCS, such as carrier identifier (ID), physical cell identifier (PCI), frequency reference point A, supplementary uplink (SUL) configuration, TA offset, SSB configuration, TDD slot format configuration, or the like. By configuring carrier parameters independent of SCS for the candidate DL BW parameter set, the network node may facilitate early BW adaptation across different carriers or cells, which may provide improved coverage, reliability, and throughput through access to additional frequency resources or cells with better link quality.

In some aspects, the parameters per candidate DL BW parameter set that may be configured for updating the initial BWP to the updated BWP may include carrier parameters per carrier SCS, such as the carrier's first usable RB offset to the point A, or a carrier BW. By configuring carrier parameters per carrier SCS for the candidate DL BW parameter set, the network node may facilitate early BW adaptation with different SCS configurations, which may provide improved coverage through larger BW or improved throughput through higher SCS.

In some aspects, the parameters per candidate DL BW parameter set that may be configured for updating the initial BWP to the updated BWP may include DL BW parameters such as DL BW ID, SCS, starting RB (e.g., offset to the carrier's first usable RB by assuming same SCS), a quantity of RBs, or a cyclic prefix (e.g., normal or extended). By configuring DL BW parameters such as DL BW ID, SCS, starting RB, quantity of RBs, or cyclic prefix for the candidate DL BW parameter set, the network node may facilitate early BW adaptation with different BW sizes and locations, which may provide improved coverage, reliability, and throughput through increased energy and frequency diversity gain associated with larger BW.

In some aspects, the parameters per candidate DL BW parameter set that may be configured for updating the initial BWP to the updated BWP may include parameters of PDCCH associated with the DL BW such as: (1) one or multiple CORESET(s) and search space(s) for various purposes, e.g., SIB 1, other system information (OSI), RAR, paging, small data transmission, multicast traffic, or paging early indication (PEI), (2) parameters per search space, such as a first PDCCH monitoring occasion per paging occasion or per PEI occasion, (3) parameters per CORESET, such as quasi-co-location (QCL) parameters (e.g., whether to follow indicated transmission configuration indicator (TCI) and which TCI to follow if two TCIs are indicated). By configuring parameters of PDCCH associated with the DL BW for the candidate DL BW parameter set, the network node may facilitate early BW adaptation with different CORESET and search space configurations, which may provide improved coverage and reliability for DL control channel reception during initial access.

In some aspects, the parameters per candidate DL BW parameter set that may be configured for updating the initial BWP to the updated BWP may include parameters of CSI-RS or CLI measurement and report associated with the DL BW. By configuring parameters of CSI-RS or CLI measurement and report associated with the DL BW for the candidate DL BW parameter set, the network node may facilitate early BW adaptation with different measurement configurations, which may enable improved link adaptation and interference management during initial access.

In some aspects, the parameters per candidate DL BW parameter set that may be configured for updating the initial BWP to the updated BWP may include parameters of PDSCH associated with the DL BW. In some aspects, the parameters of PDSCH associated with the DL BW may include time-frequency resource allocation parameters such as a list of time-domain configurations resource allocation, a frequency allocation type, a RBG-size for type 0 frequency allocation (e.g., configuring BWP or carrier allocation based on a bitmap), a virtual to actual RB interleaver, or a rate matching pattern. In some aspects, the parameters of PDSCH associated with the DL BW may include MIMO parameters such as a DMRS type, a DMRS scrambling or initialization ID, a DMRS orthogonal cover code enablement, one or more antenna port IDs, a TCI state list per TCI type, a beam application time, or a maximum quantity of MIMO layers. In some aspects, the parameters of PDSCH associated with the DL BW may include PDSCH transmission parameters such as maximum quantity of codewords, a PRB bundling type, a priority indicator, a scrambling ID, an indication of a repetition scheme, an enablement indicator for code block group transmission, an overhead indicator to account for overhead from CSI-RS and CORESET, a maximum quantity of code block groups per TB, or an MCS table. In some aspects, the parameters of PDSCH associated with the DL BW may include a quantity of HARQ processes, a cell ID for PUCCH, a list of configurations for up to two simultaneously constructed HARQ-ACK codebooks, a HARQ feedback type, or an indicator to disable the DL HARQ feedback. In some aspects, the parameters of PDSCH associated with the DL BW may include scheduling timeline parameters such as a minimum scheduling offset, or an enablement indicator for advanced processing time capability 2 for PDSCH (e.g., UE's capability to decode downlink data with shorter processing time). By configuring parameters of PDSCH associated with the DL BW for the candidate DL BW parameter set (including time-frequency resource allocation parameters, MIMO parameters, PDSCH transmission parameters, HARQ feedback parameters, and scheduling timeline parameters), the network node may facilitate early BW adaptation with different PDSCH configurations, which may provide improved coverage, reliability, and throughput for DL data channel reception during initial access through increased energy, frequency diversity gain, and MIMO gain associated with larger BW.

In some aspects, the network node may configure or there may be configuration without signaling that may provide the configuration or rule to determine the parameters per candidate UL BW parameter set for the early UL BW adaptation. As an example, the configuration may be broadcast in MIB or SIB1. By broadcasting the configuration for candidate UL BW parameter sets in MIB or SIB1, the UE may obtain the configuration prior to initiating the RACH procedure, which may reduce signaling overhead during initial access and enable faster UL BW adaptation to improve coverage, reliability, and throughput for UL transmissions.

In some aspects, the parameters per candidate UL BW parameter set that may be configured for updating the initial BWP to the updated BWP may include carrier parameters independent of SCS, such as carrier ID, PCI, frequency reference point A, SUL configuration, TA offset, SSB configuration, TDD slot format configuration, or the like. By configuring carrier parameters independent of SCS for the candidate UL BW parameter set, the network node may facilitate early UL BW adaptation across different carriers or cells, which may provide improved UL coverage, reliability, and throughput through access to additional frequency resources or cells with better link quality.

In some aspects, the parameters per candidate UL BW parameter set that may be configured for updating the initial BWP to the updated BWP may include carrier parameters per carrier SCS, such as the carrier's first usable RB offset to the point A, or a carrier BW. By configuring carrier parameters per carrier SCS for the candidate UL BW parameter set, the network node may facilitate early UL BW adaptation with different SCS configurations, which may provide improved UL coverage through larger BW or improved UL throughput through higher SCS.

In some aspects, the parameters per candidate UL BW parameter set that may be configured for updating the initial BWP to the updated BWP may include UL BW parameters such as a UL BW ID, an SCS, a starting RB (e.g., offset to the carrier's first usable RB by assuming same SCS), a quantity of RBs, cyclic prefix (e.g., normal or extended). By configuring UL BW parameters such as UL BW ID, SCS, starting RB, quantity of RBs, or cyclic prefix for the candidate UL BW parameter set, the network node may facilitate early UL BW adaptation with different BW sizes and locations, which may provide improved UL coverage, reliability, and throughput through increased energy and frequency diversity gain associated with larger BW. In some aspects, the parameters per candidate UL BW parameter set that may be configured for updating the initial BWP to the updated BWP may include parameters of PUCCH associated with the UL BW. In some aspects, the parameters of PUCCH associated with the UL BW may include a PUCCH resource ID, a PUCCH format, a maximum code rate, a quantity of slots, a modulation type, a maximum payload size, a list of timing for given PDSCH to the DL ACK, a spatial relation or a beam indication, an indicator to allow simultaneous transmission of CSI and HARQ-ACK feedback, or a waveform type (e.g., CP-OFDM or discrete Fourier transform-spread (DFT-S)). In some aspects, the parameters of PUCCH associated with the UL BW may include PUCCH time and frequency resource allocation parameters such as a starting RB, a quantity of RBs, a starting symbol index, a quantity of symbols, or an intra or inter-slot frequency hopping pattern. In some aspects, the parameters of PUCCH associated with the UL BW may include sequence related parameters such as a configuration of group or sequence hopping, a scrambling ID, a time or frequency orthogonal cover code enablement indicator, a cyclic shift, a DMRS bundling enablement indicator, or a DMRS pattern. In some aspects, the parameters of PUCCH associated with the UL BW may include power control parameters such as a PO (baseline power per PRB), an alpha (pathloss compensation factor), a closed-loop index, or a pathloss RS. By configuring parameters of PUCCH associated with the UL BW for the candidate UL BW parameter set (including PUCCH resource parameters, time and frequency resource allocation parameters, sequence related parameters, and power control parameters), the network node may facilitate early UL BW adaptation with different PUCCH configurations, which may provide improved coverage and reliability for UL control channel transmission during initial access through increased frequency diversity gain associated with larger BW and frequency hopping.

In some aspects, the parameters per candidate UL BW parameter set that may be configured for updating the initial BWP to the updated BWP may include parameters of SRS transmission associated with the UL BW. By configuring parameters of SRS transmission associated with the UL BW for the candidate UL BW parameter set, the network node may facilitate early UL BW adaptation with different SRS configurations, which may enable improved channel estimation and link adaptation during initial access.

In some aspects, the parameters per candidate UL BW parameter set that may be configured for updating the initial BWP to the updated BWP may include parameters of PUSCH associated with the UL BW. In some aspects, the parameters of PUSCH associated with the UL BW may include time-frequency Resource allocation parameters such as a list of time-domain configurations resource allocation, a quantity of repetitions, a repetition type, a frequency allocation type, a RBG-size for type 0 frequency allocation, an intra or inter-slot frequency hopping pattern, an invalid symbol pattern, or time-domain orthogonal cover code configuration. In some aspects, the parameters of PUSCH associated with the UL BW may include MIMO parameters such as a configuration of group or sequence hopping, a DMRS type, codebook type (e.g., coherent, partial coherent, non-coherent), a maximum rank, a DMRS scrambling or initialization ID, one or more antenna port IDs, a DMRS bundling indicator, or a TCI indication. In some aspects, the parameters of PUSCH associated with the UL BW may include PUSCH transmission parameters such as a PUSCH type (e.g., codebook or non-codebook), a waveform type (e.g., CP-OFDM or DFT-S), a data scrambling ID, a modulation type, an MCS table, a priority indicator, or a simultaneous multi-panel transmission scheme type. In some aspects, the parameters of PUSCH associated with the UL BW may include scheduling timeline parameters such as a minimum scheduling offset, an indicator to allow UCI on PUSCH, a beta offset, or an available slot counting enablement. In some aspects, the parameters of PUSCH associated with the UL BW may include power control parameters such as a PO, an alpha, a closed-loop index, a pathloss RS, an UL full power indicator, or list of SSB/CSI-RS resources for power-based maximum power reduction (P-MPR) report. By configuring parameters of PUSCH associated with the UL BW for the candidate UL BW parameter set (including time-frequency resource allocation parameters, MIMO parameters, PUSCH transmission parameters, scheduling timeline parameters, and power control parameters), the network node may facilitate early UL BW adaptation with different PUSCH configurations, which may provide improved coverage, reliability, and throughput for UL data channel transmission during initial access through increased energy, frequency diversity gain, and MIMO gain associated with larger BW.

In some aspects, the capability indication associated with the early BW adaptation may include (1) a capability for early BW adaptation, including the support of switch of BW parameters for the same BWP, switch of BWP, switch of carrier/cell, or switch of CA/DC configuration, or (2) a maximum channel bandwidth supported in each band for DL and UL separately and for each SCS that UE supports within a single CC or aggregated across CCs. The capability indication associated with the early BW adaptation may also include, for each of DL and UL direction, (1) one or more maximum quantities of candidate BW parameter sets, candidate BWPs, candidate carriers/cells, or candidate CA/DC configurations, (2) whether multiple candidates may have more than one SCS, or (3) whether DL and UL selected candidates may have different SCSs. In some aspects, for a candidate CA/DC configuration (e.g., each candidate CA/DC configuration), the UE may also indicate one or more supported CC combinations, a quantity of PUCCH groups, a quantity of SCSs per PUCCH group, or a quantity of timing advance groups (TAGs). By enabling the UE to indicate capability for early BW adaptation (including support of switch of BW parameters, switch of BWP, switch of carrier/cell, or switch of CA/DC configuration, as well as maximum channel bandwidth supported), the network node may make informed decisions regarding early BW adaptation based on UE capability, which may improve initial access performance by providing better coverage, reliability, and throughput while avoiding configurations that exceed UE capability.

In some aspects, the capability indication associated with the early BW adaptation may also include other BW associated operation capabilities, such as indication of support of: a DL/UL maximum rank, at least one DMRS type, at least one repetition type, a maximum repetition quantity, a maximum TCI quantity, a maximum CORESET quantity, a minimum time offset for scheduling, a HARQ feedback, a beam application, a maximum HARQ quantity, a maximum quantity of code block groups (CBGs) per TB, a maximum codeword quantity, an MCS table, at least one PUCCH format, at least one maximum PUCCH resource quantity, a DMRS bundling, at least one frequency hopping type, a group and sequence hopping, at least one codebook type, at least one PUSCH type, at least one waveform type, at least one modulation type, a full power, or a simultaneous multi-panel PUSCH transmission scheme. By enabling the UE to indicate other BW associated operation capabilities (such as maximum rank, DMRS type, repetition type, frequency hopping type, codebook type, waveform type, or modulation type), the network node may configure the updated BWP with parameters that match UE capability, which may improve initial access performance by providing better coverage, reliability, and throughput through appropriate MIMO, repetition, or frequency hopping configurations. In some aspects, the capability indication associated with the early BW adaptation may also include capability regarding an “action time” for the new BW parameter set for the updated BWP to be effective, which may include: (1) an action time that may be at least a quantity (e.g., denoted by X, which is an integer) of symbols or slots from a reference time, or (2) whether X and its SCS may depend on the SCS of the previous BW or the updated BW (e.g., the smallest SCS, whether the cell changes or not). The UE may provide a respective X for different scenarios. In some aspects, the capability indication associated with the early BW adaptation may also include indication of support or non-support of dynamic indication for early BW adaptation, e.g., via DCI or medium access control (MAC) control element (MAC-CE), and whether adapted BW (updated BWP) may be without SSB or CORESET #0. By enabling the UE to indicate capability regarding action time for the new BW parameter set to be effective (including the quantity of symbols or slots from a reference time and whether the action time depends on SCS of the previous BW or the updated BW), the network node may configure the action time based on UE capability, which may reduce the delay for early BW adaptation to become effective and improve initial access performance by providing better coverage, reliability, and throughput sooner during initial access.

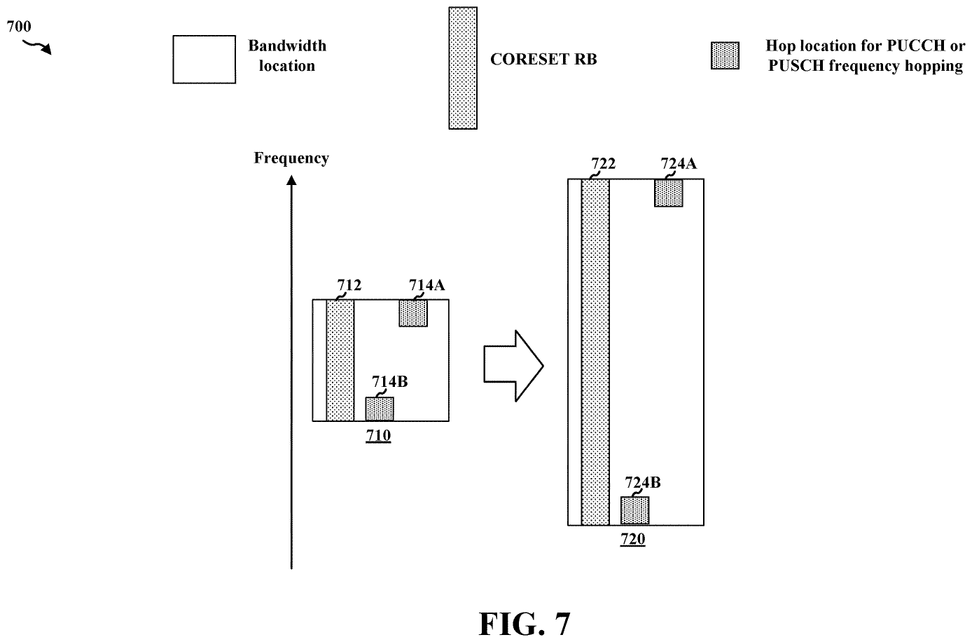

FIG. 7 is a diagram 700 illustrating example adaptation from an initial BWP to an updated BWP, in accordance with various aspects of the present disclosure. As illustrated in FIG. 7, the initial BWP may be at a location 710 and may include a set of CORESET RBs 712, a first hop location 714A for PUCCH or PUSCH frequency hopping, and a second hop location 714B for PUCCH or PUSCH frequency hopping. The updated BWP may be at a location 720 and may be larger than the initial BWP. The updated BWP may include a set of CORESET RBs 722 that includes more RBs than the set of CORESET RBs 712, a first hop location 724A for PUCCH or PUSCH frequency hopping, and a second hop location 724B for PUCCH or PUSCH frequency hopping.

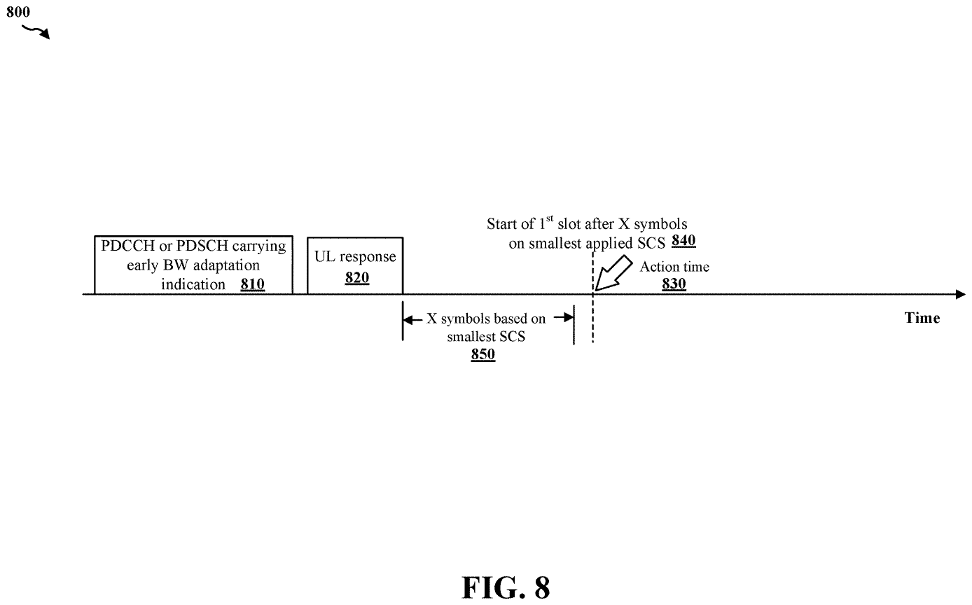

In some aspects, the network node may configure or the UE may be configured with (e.g., without signaling) the action time for the new BW parameter set associated with the updated BWP to be effective (e.g., the parameter X may be broadcasted in SIB1, or indicated in the same PDCCH or PDSCH carrying the early BW adaptation indication). In some aspects, the action time may be at least X symbols or slots from a reference time. The reference time may be the end of DL message carrying the early BW adaptation indication (e.g., message 2 or message 4), the end of the corresponding UL response (e.g., message 3 or ACK of message 4), the start of the slot containing the DL message, or the end of X-th symbol of the slot containing the DL message. The X and its SCS may depend on the SCS of the previous BW or the new BW in the respective direction (e.g., the smallest SCS associated with the initial BWP and the updated BWP), whether the cell changes, or the corresponding UE capability. In some aspects, the final action time may the rounded to the next slot boundary after the X symbols. For DL or UL BW adaptation, the next slot may be the next DL or UL slot based on the SCS of the updated BWP. In some aspects, no reception or transmission may be performed or expected during the action time (e.g., earliest scheduled reception or transmission may be after action time). By configuring the action time for the new BW parameter set to be effective based on a reference time and a quantity of symbols or slots, the network node may provide a predictable transition from the initial BWP to the updated BWP, which may improve initial access performance by providing better coverage, reliability, and throughput for the remaining messages after the action time while avoiding reception or transmission during the transition period. FIG. 8 is a diagram 800 illustrating an example timeline associated with BW adaptation, in accordance with various aspects of the present disclosure. As illustrated in FIG. 8, at 810, a PDCCH or a PDSCH (e.g., as a RACH message) carrying early BW adaptation indication 810 may be transmitted to the UE, and the UE may respond with a UL response 820. The action time 830 may be defined based on a start time 840 of a first slot after X symbols 850 based on a smallest SCS. By defining the action time based on a start time of a first slot after X symbols based on a smallest SCS, the network node may provide a consistent and predictable transition from the initial BWP to the updated BWP across different SCS configurations, which may improve initial access performance by providing better coverage, reliability, and throughput for the remaining messages after the action time.

In some aspects, early BW adaptation may be used for (1) idle UE transitioning to connected UE, (2) 4-step or 2-step RACH based RRC resume procedure for inactive UE transitioning to connected UE, or (3) 4-step or 2-step RACH based small data transmission procedure for inactive UE transmitting small amount of data. In some aspects, the early BW adaptation indication may be applicable to cell group (CG) based access, including CG-based RRC setup, CG-based RRC resume, and CG-based small data transmission (SDT). As an example, when TA is known at UE, message 1 and message 2 may be skipped, and the UE may directly transmit RRC setup request or RRC resume request on CG resource(s), and the network node may indicate early BW adaptation in the following DL messages. By enabling early BW adaptation for various initial access procedures (including idle UE transitioning to connected UE, RRC resume procedure for inactive UE, small data transmission procedure for inactive UE, and CG-based access), the network node may improve initial access performance across different UE states and access types by providing better coverage, reliability, and throughput through early BW adaptation.

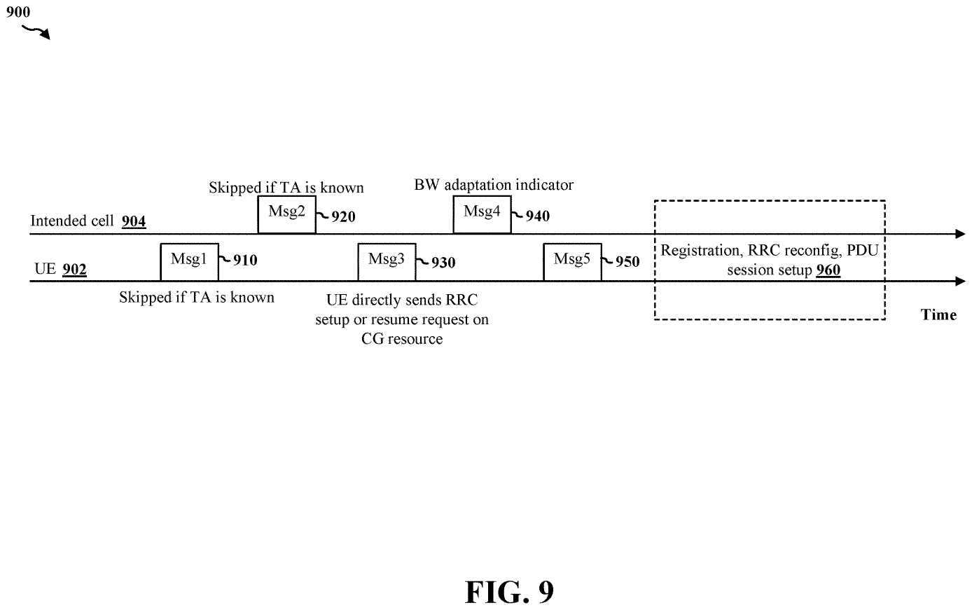

FIG. 9 is a diagram 900 illustrating an example timeline associated with BW adaptation, in accordance with various aspects of the present disclosure. As illustrated in FIG. 9, because TA may be known at the UE 902, the UE 902 may skip message 1 910 and the intended cell 904 may skip message 2 920. The UE may directly send message 3 930 which may include the RRC setup request or the RRC resume request on CG resource(s), and receive a message 4 940 that indicates BW adaptation for updating an initial BWP to an updated BWP for subsequent messages, such as message 5 950 or message exchanged at 960 for registration, RRC reconfiguration, or PDU session set-up. By enabling the UE to skip message 1 and message 2 when TA is known and directly send message 3 on CG resource(s), the network node may indicate early BW adaptation in message 4, which may reduce latency for initial access while improving coverage, reliability, and throughput for the remaining messages through early BW adaptation.

In some aspects, the network node network node's early BW adaptation may be independent of UE indication. In some aspects, as described herein, to facilitate network node's early BW adaptation decision, UE may provide corresponding indicator (indication of UE desire/preference) and capability before the network node transmits network node's early BW adaptation decision. For a UE indication (e.g., 506 or 606) that facilitates (e.g., triggers) the early BW adaptation, the indication may be: (1) an indication of using more BW (or less BW), (2) an explicit indication of which DL or UL BW candidate parameter set(s) are selected by the UE (which may be adhered to or ignored by the network node), (3) implicit indicator(s) based on UE feedback of link quality metric (e.g., SSB related reference signal received power (RSRP) or other metrics such as received signal strength indicator (RSSI), signal to interference and noise ratio (SINR), or the like, being below a configured threshold, which may imply more BW may improve performance), (4) implicit indicator(s) based on UE feedback of certain traffic condition related parameters, such as buffered data amount, latency, reliability specification, or the like. By enabling the UE to provide an indicator (indication of UE desire/preference) or capability indication that facilitates the network node's early BW adaptation decision, the network node may make informed decisions regarding early BW adaptation based on UE desire/preference and link quality, which may improve initial access performance by providing better coverage, reliability, and throughput through appropriate BW adaptation.

In some aspects, for a UE capability indication (e.g., 506 or 606) that facilitates (e.g., triggers) the early BW adaptation, the UE capability indication associated with the early BW adaptation may indicate or imply the various parameters as described herein. In some aspects, a combination of capability indication and indicator (e.g., desire indication) may be used where indicator may be used for a first set of parameters and capability indication may be used for a second set of parameters. By enabling a combination of capability indication and indicator (desire/preference indication) to be used for different sets of parameters, the network node may obtain both UE capability and UE desire/preference information, which may improve initial access performance by providing better coverage, reliability, and throughput through appropriate BW adaptation that matches both UE capability and UE desire/preference.

In some aspects, the UE indicator associated with the early BW adaptation (e.g., such as an implicit or explicit UE desire indication) or the UE capability indication (e.g., 506 or 606) may be indicated by parameters related to PRACH transmission for message 1 or message A PRACH in 4 or 2-step RACH, respectively. In some aspects, PRACH parameters include RO index or time/frequency resource, a preamble index, a root sequence, an SCS, or a repetition quantity. Based on the indicated parameters, the network node may configure the early BW adaptation and transmit the early BW adaptation indication in message B, message 2, or message 4, which may trigger the BW update (from the initial BWP to the updated BWP) after the action time. By enabling the UE indicator or capability indication to be indicated by parameters related to PRACH transmission for message 1 or message A PRACH, the network node may receive the UE indicator or capability indication as early as the first UL message during initial access, which may enable the network node to indicate early BW adaptation as early as message 2 or message B and improve initial access performance by providing better coverage, reliability, and throughput for the remaining messages.

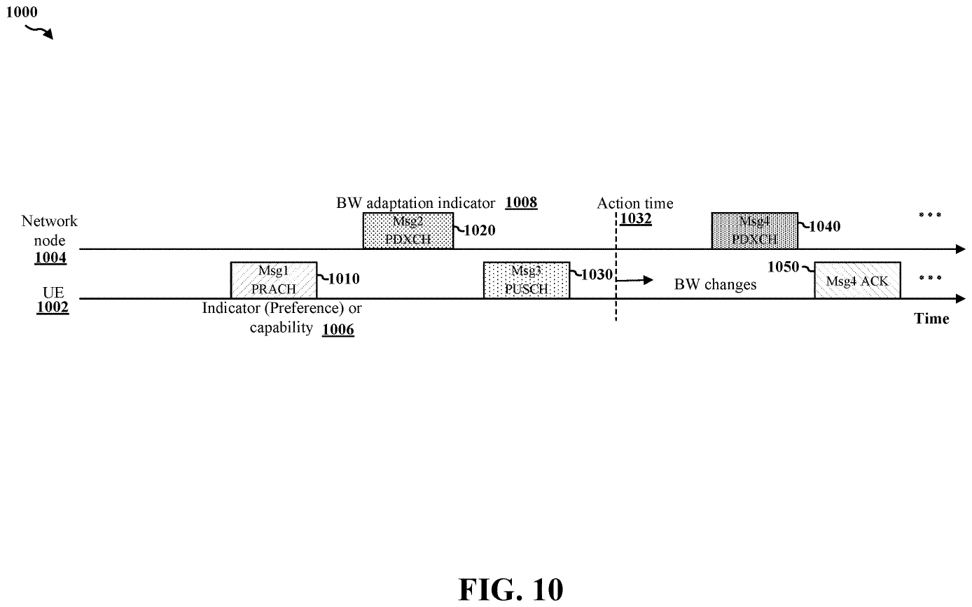

FIG. 10 is a diagram 1000 illustrating an example timeline associated with BW adaptation, in accordance with various aspects of the present disclosure. As illustrated in FIG. 10, the UE 1002 may transmit a message 1 1010 which includes the UE indicator or the UE capability indication 1006 associated with the early BW adaptation, and receive a message 2 1020 that includes the early BW adaptation indicator 1008 from the network node 1004. Before the action time ends at 1032, the UE may transmit a message 3 1030 based on the initial BWP. After the action time ends at 1032, the UE 1002 may receive a message 4 1040 based on the updated BWP and transmit an ACK 1050 associated with the message 4 1040. By enabling the network node to transmit the early BW adaptation indicator in message 2 based on the UE indicator or capability indication in message 1, the UE may adapt its BW after the action time and receive message 4 based on the updated BWP, which may improve initial access performance by providing better coverage, reliability, and throughput for message 4 and subsequent messages through increased energy and frequency diversity gain associated with larger BW.

In some aspects, the UE indicator associated with the early BW adaptation (e.g., such as an implicit or explicit UE indication) or the UE capability indication (e.g., 506 or 606) may be indicated by parameters related to PRACH transmission for message 3 or message B PRACH in 4 or 2-step RACH, respectively, or a later UL message such as message 5. In some aspects, dedicated MAC-CE or UCI may be used to carry the UE indicator associated with the early BW adaptation (e.g., such as an implicit or explicit UE indication) or the UE capability indication. The network node may can indicate early BW adaptation in DL messages such as message 4 or message B, which triggers BW changes after the action time. In some aspects, the UL message (such as a RACH message or a first UL message on a CG resource) carrying the UE indicator associated with the early BW adaptation (e.g., such as an implicit or explicit UE indication) or the UE capability indication may directly trigger BW adaptation after the action time. In some aspects, the network node may also inquire the UE to report UE indicator or capability before sending out the early BW adaptation indicator. For example, candidate BW parameter sets and interested capabilities may be sent in a broadcast message or determined without signaling. The network node may transmit inquiry indicator (such as a one-bit indicator) in one DL message in initial access, such as message 2, and the UE may respond with the UE selected BW parameter set(s) and the interested capabilities. As another example, the network node may list candidate BW parameter sets and interested capabilities, or corresponding IDs in one DL message in initial access, such as message 2, and the UE may respond with the selected BW parameter set(s) and the interested capabilities. By enabling the UE indicator or capability indication to be indicated in message 3 or a later UL message, or by enabling the network node to inquire the UE to report UE indicator or capability before sending out the early BW adaptation indicator, the network node may obtain more detailed UE indicator or capability information, which may improve initial access performance by providing better coverage, reliability, and throughput through more informed BW adaptation decisions.

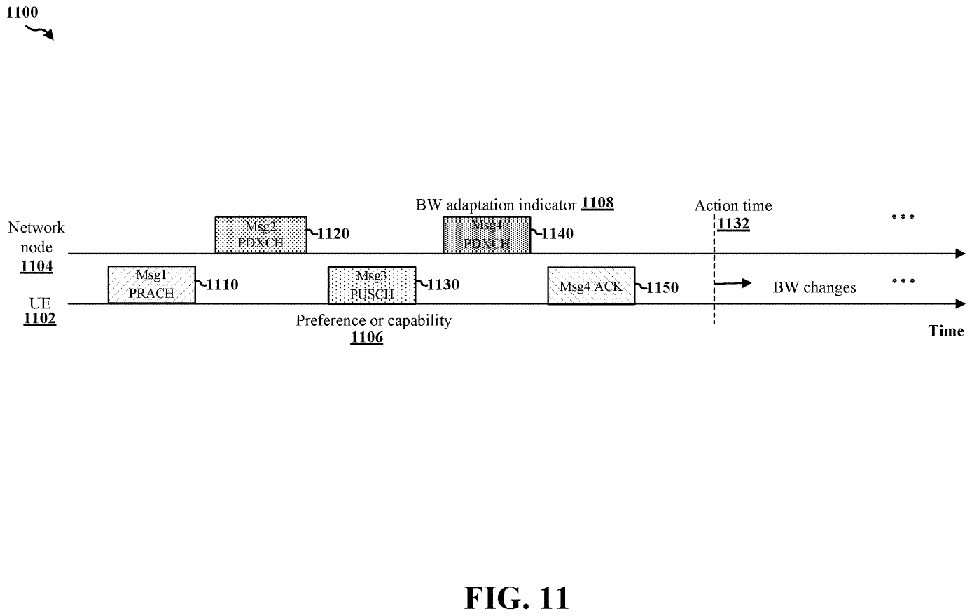

FIG. 11 is a diagram 1100 illustrating an example timeline associated with BW adaptation, in accordance with various aspects of the present disclosure. As illustrated in FIG. 11, the UE 1102 may transmit a message 1 1110 receive a message 2 1120 from the network node 1104. In some aspects, the message 2 1120 may include an inquiry indicator. In some aspects, the message 2 1120 may not include the inquiry indicator. Based on the inquiry indicator (if it was sent) or independent of the inquiry indicator, the UE may transmit a message 3 1130 that includes the UE indicator or the UE capability indication 1106 associated with the early BW adaptation. The network node 1104 may transmit a message 4 1108 that includes the early BW adaptation indicator 1108. The early BW adaptation indicator 1108 or the message 3 1130 may trigger the updated of the BWP. Before the action time ends at 1132, the UE may transmit an ACK 1150 of the message 4 1140 based on the initial BWP. After the action time ends at 1132, the UE 1102 and the network node 1104 may communicate based on the updated BWP. By enabling the network node to transmit an inquiry indicator in message 2 and receive the UE indicator or capability indication in message 3, the network node may obtain UE indicator or capability information before transmitting the early BW adaptation indicator in message 4, which may improve initial access performance by providing better coverage, reliability, and throughput through more informed BW adaptation decisions while maintaining flexibility in the signaling procedure.

In some aspects, the UE indicator or the UE capability indication associated with the early BW adaptation may be included in a message 1 that includes multiple parts (e.g., two parts). In some aspects, the UE indicator or the UE capability indication associated with the early BW adaptation may be indicated by the combination of any parameters associated with the two parts, such as RO time/frequency resource, a root sequence ID, or a preamble ID. For example, a particular combination of the preamble ID offset(s) between the two parts may indicate corresponding selected candidate BW parameter set(s), respectively. By enabling the UE indicator or capability indication to be included in a message 1 that includes multiple parts (for example, two parts), the UE may indicate more detailed desire/preference or capability information through the combination of parameters associated with the two parts, which may improve initial access performance by providing better coverage, reliability, and throughput through more informed BW adaptation decisions.

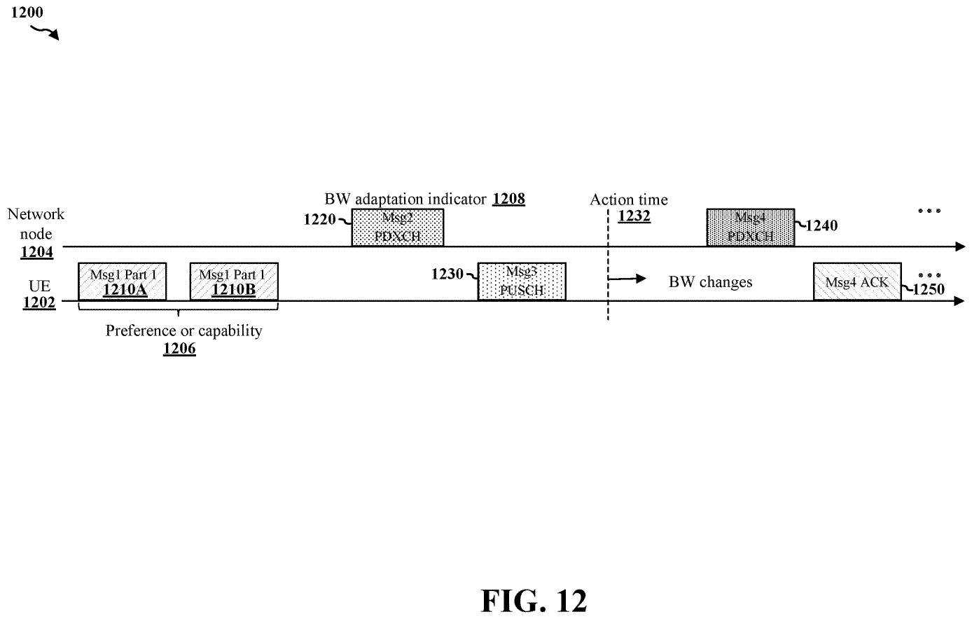

FIG. 12 is a diagram 1200 illustrating an example timeline associated with BW adaptation, in accordance with various aspects of the present disclosure. As illustrated in FIG. 12, the UE 1202 may transmit a message 1 that includes two parts, a first part 1210A and a second part 1210B, which may collectively include the UE indicator or the UE capability indication 1206 associated with the early BW adaptation, and receive a message 2 1220 that includes the early BW adaptation indicator 1208 from the network node 1204. Before the action time ends at 1232, the UE may transmit a message 3 1230 based on the initial BWP. After the action time ends at 1232, the UE 1202 may receive a message 4 1240 based on the updated BWP and transmit an ACK 1250 associated with the message 4 1240. By enabling the UE to transmit a message 1 that includes two parts (a first part and a second part) which collectively include the UE indicator or capability indication, the network node may receive more detailed UE indicator or capability information as early as message 1, which may enable the network node to indicate early BW adaptation in message 2 and improve initial access performance by providing better coverage, reliability, and throughput for the remaining messages through increased energy and frequency diversity gain associated with larger BW.

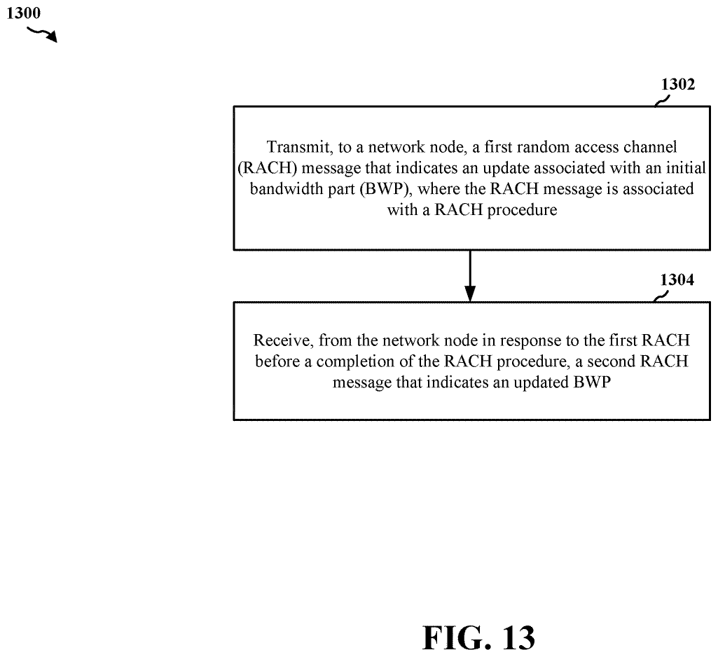

FIG. 13 is a flowchart 1300 of a method of wireless communication. The method may be performed by a UE (e.g., the UE 104, the UE 502, the UE 602, the UE 902, the UE 1002, the UE 1102, the UE 1202; the apparatus 1504).

At 1302, the UE may transmit, to a network node, a first RACH message that indicates an update associated with an initial BWP, where the first RACH message is associated with a RACH procedure. For example, the UE (e.g., 502, 602, 902, 1002, 1102, or 1202) may transmit, to a network node (e.g., 504, 604, 904, 1004, 1104, or 1204), a first RACH message (e.g., 510, 530, 610, 930, 1010, 1130, 1210A, or 1210B) that indicates an update associated with an initial BWP (e.g., 710), where the first RACH message is associated with a RACH procedure. In some aspects, 1302 may be performed by RACH component 198. As an example, the “update” may also be considered as a candidate update before it is applied.

At 1304, the UE may receive, from the network node in response to the first RACH before a completion of the RACH procedure, a second RACH message that indicates an updated BWP. For example, the UE (e.g., 502, 602, 902, 1002, 1102, or 1202) may receive, from the network node in response to the first RACH before a completion of the RACH procedure, a second RACH message (e.g., 520, 540, 612, 940, 1020, 1140, or 1220) that indicates an updated BWP (e.g., 720). In some aspects, 1304 may be performed by RACH component 198.

In some aspects, the second RACH message that indicates the updated BWP includes an indication of an early bandwidth adaptation (e.g., 508, 608, 1008, 1108, 1208), and where the second RACH message is before a RRC reconfiguration.

In some aspects, the early bandwidth adaptation and the update is based on a change of a set of bandwidth parameters associated with the initial BWP, and where the updated BWP is associated with an updated set of bandwidth parameters. In some aspects, the early bandwidth adaptation and the update is based on a change (e.g., change of frequency domain location) of a first candidate BWP associated with the initial BWP, and where the updated BWP is associated with a second candidate BWP. In some aspects, the early bandwidth adaptation and the update is based on a change of a first carrier or a first cell associated with the initial BWP, and where the updated BWP is associated with a second carrier or a second cell (e.g., change from the first cell or the first carrier to a second cell or a second carrier to a different location). In some aspects, the early bandwidth adaptation and the update is based on a change of a first carrier aggregation configuration or a first dual connectivity configuration associated with the initial BWP, and where the updated BWP is associated with a second carrier aggregation configuration or a second dual connectivity configuration. In some aspects, the indication of the early bandwidth adaptation is included in a random access response (e.g., Msg 2), a contention resolution message (e.g., Msg 4), or a message after contention resolution (e.g., Msg 6). In some aspects, the indication of the early bandwidth adaptation is associated with an action time (e.g., 830, 1032, 1132, or 1232) where the updated BWP is effective, and where the action time is included in the second RACH message or an SIB.

In some aspects, the first RACH message indicates the update based on an indicator (e.g., desire indicator) regarding the update, a set of bandwidth parameters associated with the updated BWP, a link quality metric feedback, an operation parameter associated with the RACH procedure, or a traffic-related feedback. In some aspects, the first RACH message indicates the update based on a capability indication associated with the update that indicates at least one of: a maximum supported channel bandwidth, a bandwidth adaptation action time, a maximum rank, or a frequency hopping type associated with the UE. In some aspects, the first RACH message is a RACH preamble message with or without UE MAC-CE, RRC request message, or a beam failure recovery request message.

By transmitting the first RACH message that indicates an update associated with an initial BWP and receiving the second RACH message that indicates an updated BWP before completion of the RACH procedure, the UE may adapt its bandwidth before completion of the RACH procedure and before RRC reconfiguration, which may improve initial access performance by providing better coverage, reliability, and throughput for the remaining messages during initial access. For example, the network node may have a constant power spectral density (PSD) in the DL and more BW may provide more energy, frequency diversity gain, and throughput. In some aspects, the early BW adaptation may be beneficial for idle UEs at a cell edge or other UEs that may have a poor link quality with the network node. In some aspects, in addition to adapting to a larger BW, adapting to a smaller BW may also be possible to save power at the UE.

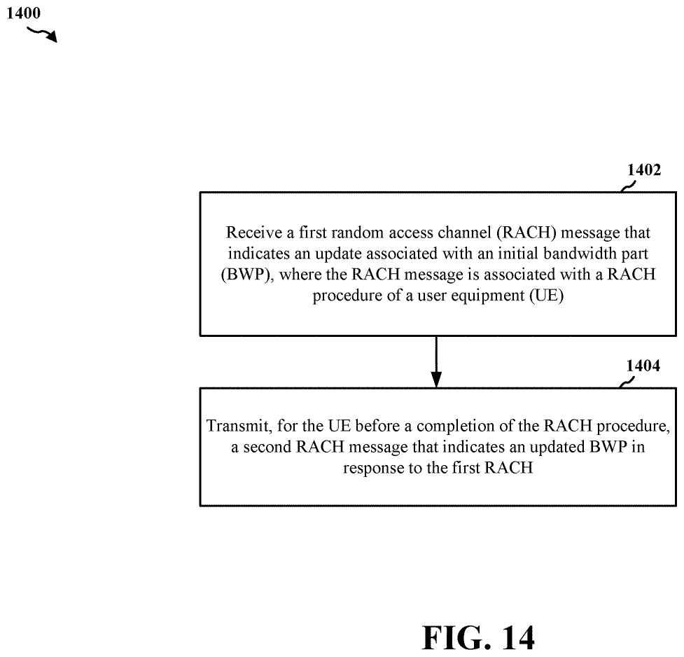

FIG. 14 is a flowchart 1400 of a method of wireless communication. The method may be performed by a network node (e.g., the base station 102, the network node 504, the network node 604, the intended cell 904, the network node 1004, the network node 1104, the network node 1204, the network entity 1502, the network entity 1602).

At 1402, the network node may receive a first RACH message that indicates an update associated with an initial BWP, where the first RACH message is associated with a RACH procedure of a UE. For example, the network node (e.g., 504, 604, 904, 1004, 1104, or 1204) may receive a first RACH message (e.g., 510, 530, 610, 930, 1010, 1130, 1210A, or 1210B) that indicates an update associated with an initial BWP (e.g., 710), where the first RACH message is associated with a RACH procedure of a UE (e.g., 502, 602, 902, 1002, 1102, or 1202). In some aspects, 1402 may be performed by RACH component 199.

At 1404, the network node may transmit, for the UE before a completion of the RACH procedure, a second RACH message that indicates an updated BWP in response to the first RACH. For example, the network node (e.g., 504, 604, 904, 1004, 1104, or 1204) may transmit, for the UE (e.g., 502, 602, 902, 1002, 1102, or 1202) before a completion of the RACH procedure, a second RACH message (e.g., 520, 540, 612, 940, 1020, 1140, or 1220) that indicates an updated BWP (e.g., 720). In some aspects, 1404 may be performed by RACH component 199.

In some aspects, the second RACH message that indicates the updated BWP includes an indication of an early bandwidth adaptation (e.g., 508, 608, 1008, 1108, 1208), and where the second RACH message is before a RRC reconfiguration.

In some aspects, the early bandwidth adaptation and the update is based on a change of a set of bandwidth parameters associated with the initial BWP, and where the updated BWP is associated with an updated set of bandwidth parameters. In some aspects, the early bandwidth adaptation and the update is based on a change of a first candidate BWP associated with the initial BWP, and where the updated BWP is associated with a second candidate BWP. In some aspects, the early bandwidth adaptation and the update is based on a change of a first carrier or a first cell associated with the initial BWP, and where the updated BWP is associated with a second carrier or a second cell. In some aspects, the early bandwidth adaptation and the update is based on a change of a first carrier aggregation configuration or a first dual connectivity configuration associated with the initial BWP, and where the updated BWP is associated with a second carrier aggregation configuration or a second dual connectivity configuration. In some aspects, the indication of the early bandwidth adaptation is included in a random access response (e.g., Msg 2), a contention resolution message (e.g., Msg 4), or a message after contention resolution (e.g., Msg 6). In some aspects, the indication of the early bandwidth adaptation is associated with an action time (e.g., 830, 1032, 1132, or 1232) where the updated BWP is effective, and where the action time is included in the second RACH message or an SIB.

In some aspects, the first RACH message indicates the update based on an indicator (e.g., desire indicator) regarding the update, a set of bandwidth parameters associated with the updated BWP, a link quality metric feedback, an operation parameter associated with the RACH procedure, or a traffic-related feedback. In some aspects, the first RACH message indicates the update based on a capability indication associated with the update that indicates at least one of: a maximum supported channel bandwidth, a bandwidth adaptation action time, a maximum rank, or a frequency hopping type associated with the UE. In some aspects, the first RACH message is a RACH preamble message with or without UE MAC-CE, RRC request message, or a beam failure recovery request message.

By receiving the first RACH message that indicates an update associated with an initial BWP and transmitting the second RACH message that indicates an updated BWP before completion of the RACH procedure, the network node may enable the UE to adapt its bandwidth before completion of the RACH procedure and before RRC reconfiguration, which may improve initial access performance by providing better coverage, reliability, and throughput for the remaining messages during initial access. For example, the network node may have a constant power spectral density (PSD) in the DL and more BW may provide more energy, frequency diversity gain, and throughput. In some aspects, the early BW adaptation may be beneficial for idle UEs at a cell edge or other UEs that may have a poor link quality with the network node. In some aspects, in addition to adapting to a larger BW, adapting to a smaller BW may also be possible to save power at the UE.

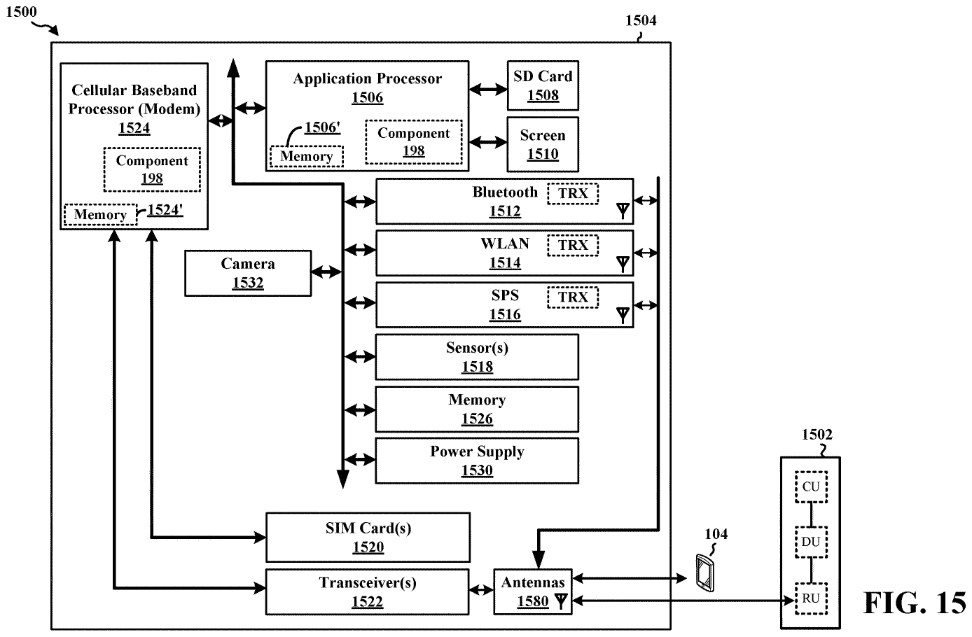

FIG. 15 is a diagram 1500 illustrating an example of a hardware implementation for an apparatus 1504. The apparatus 1504 may be a UE, a component of a UE, or may implement UE functionality. In some aspects, the apparatus 1504 may include at least one cellular baseband processor 1524 (also referred to as a modem) coupled to one or more transceivers 1522 (e.g., cellular RF transceiver). The cellular baseband processor(s) 1524 may include at least one on-chip memory 1524′. In some aspects, the apparatus 1504 may further include one or more subscriber identity modules (SIM) cards 1520 and at least one application processor 1506 coupled to a secure digital (SD) card 1508 and a screen 1510. The application processor(s) 1506 may include on-chip memory 1506′. In some aspects, the apparatus 1504 may further include a Bluetooth module 1512, a WLAN module 1514, an SPS module 1516 (e.g., GNSS module), one or more sensor modules 1518 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1526, a power supply 1530, and/or a camera 1532. The Bluetooth module 1512, the WLAN module 1514, and the SPS module 1516 may include an on-chip transceiver (TRX) (or in some cases, just a receiver (RX)). The Bluetooth module 1512, the WLAN module 1514, and the SPS module 1516 may include their own dedicated antennas and/or utilize the antennas 1580 for communication. The cellular baseband processor(s) 1524 communicates through the transceiver(s) 1522 via one or more antennas 1580 with the UE 104 and/or with an RU associated with a network entity 1502. The cellular baseband processor(s) 1524 and the application processor(s) 1506 may each include a computer-readable medium/memory 1524′, 1506′, respectively. The additional memory modules 1526 may also be considered a computer-readable medium/memory. Each computer-readable medium/memory 1524′, 1506′, 1526 may be non-transitory. The cellular baseband processor(s) 1524 and the application processor(s) 1506 are each responsible for general processing, including the execution of software stored on the computer-readable medium/memory. The software, when executed by the cellular baseband processor(s) 1524/application processor(s) 1506, causes the cellular baseband processor(s) 1524/application processor(s) 1506 to perform the various functions described supra. The computer-readable medium/memory may also be used for storing data that is manipulated by the cellular baseband processor(s) 1524/application processor(s) 1506 when executing software. The cellular baseband processor(s) 1524/application processor(s) 1506 may be a component of the UE 350 and may include the at least one memory 360 and/or at least one of the TX processor 368, the RX processor 356, and the controller/processor 359. In one configuration, the apparatus 1504 may be at least one processor chip (modem and/or application) and include just the cellular baseband processor(s) 1524 and/or the application processor(s) 1506, and in another configuration, the apparatus 1504 may be the entire UE (e.g., see UE 350 of FIG. 3) and include the additional modules of the apparatus 1504.

As discussed supra, the RACH component 198 may be configured to transmit, to a network node, a first random access channel (RACH) message that indicates an update associated with an initial bandwidth part (BWP), where the first RACH message is associated with a RACH procedure. In some aspects, the RACH component 198 may be further configured to receive, from the network node in response to the first RACH before a completion of the RACH procedure, a second RACH message that indicates an updated BWP. The RACH component 198 may be within the cellular baseband processor(s) 1524, the application processor(s) 1506, or both the cellular baseband processor(s) 1524 and the application processor(s) 1506. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1504 may include a variety of components configured for various functions. In one configuration, the apparatus 1504, and in particular the cellular baseband processor(s) 1524 and/or the application processor(s) 1506, may include means for transmitting, to a network node, a first random access channel (RACH) message that indicates an update associated with an initial bandwidth part (BWP), where the first RACH message is associated with a RACH procedure. In some aspects, the apparatus 1504 may include means for receiving, from the network node in response to the first RACH before a completion of the RACH procedure, a second RACH message that indicates an updated BWP. The means may be the component 198 of the apparatus 1504 configured to perform the functions recited by the means. As described supra, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means.

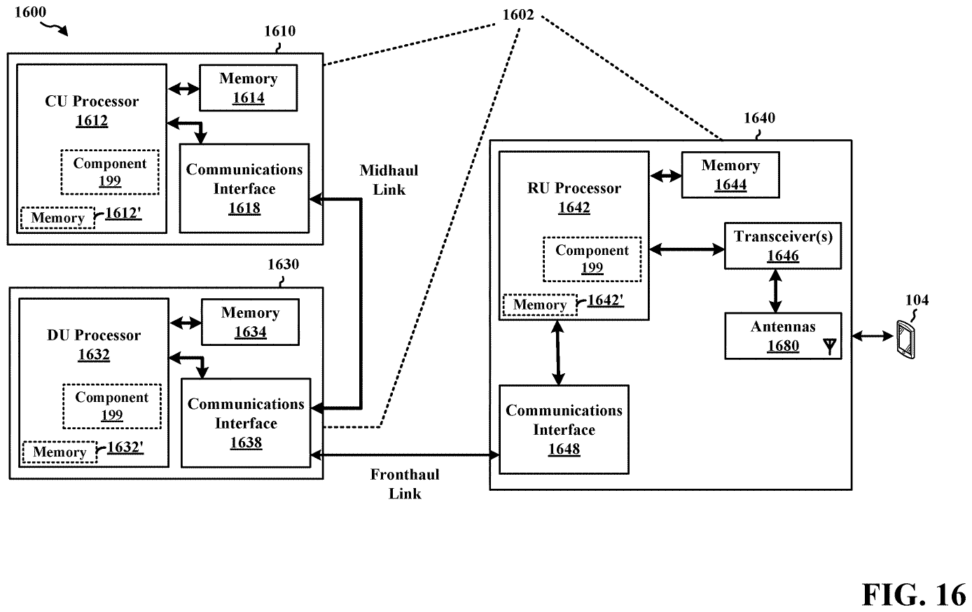

FIG. 16 is a diagram 1600 illustrating an example of a hardware implementation for a network entity 1602. The network entity 1602 may be a BS, a component of a BS, or may implement BS functionality. The network entity 1602 may include at least one of a CU 1610, a DU 1630, or an RU 1640. For example, depending on the layer functionality handled by the component 199, the network entity 1602 may include the CU 1610; both the CU 1610 and the DU 1630; each of the CU 1610, the DU 1630, and the RU 1640; the DU 1630; both the DU 1630 and the RU 1640; or the RU 1640.

The CU 1610 may include at least one CU processor 1612. The CU processor(s) 1612 may include on-chip memory 1612′. In some aspects, the CU 1610 may further include additional memory modules 1614 and a communications interface 1618. The CU 1610 communicates with the DU 1630 through a midhaul link, such as an F1 interface. The DU 1630 may include at least one DU processor 1632. The DU processor(s) 1632 may include on-chip memory 1632′. In some aspects, the DU 1630 may further include additional memory modules 1634 and a communications interface 1638. The DU 1630 communicates with the RU 1640 through a fronthaul link. The RU 1640 may include at least one RU processor 1642. The RU processor(s) 1642 may include on-chip memory 1642′. In some aspects, the RU 1640 may further include additional memory modules 1644, one or more transceivers 1646, antennas 1680, and a communications interface 1648. The RU 1640 communicates with the UE 104. The on-chip memory 1612′, 1632′, 1642′ and the additional memory modules 1614, 1634, 1644 may each be considered a computer-readable medium/memory. Each computer-readable medium/memory may be non-transitory. Each of the processors 1612, 1632, 1642 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the RACH component 199 may be configured to receive a first random access channel (RACH) message that indicates an update associated with an initial bandwidth part (BWP), where the first RACH message is associated with a RACH procedure of a user equipment (UE). In some aspects, the RACH component 199 may be further configured to transmit, for the UE before a completion of the RACH procedure, a second RACH message that indicates an updated BWP in response to the first RACH. The RACH component 199 may be within one or more processors of one or more of the CU 1610, DU 1630, and the RU 1640. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1602 may include a variety of components configured for various functions. In one configuration, the network entity 1602 may include means for receiving a first random access channel (RACH) message that indicates an update associated with an initial bandwidth part (BWP), where the first RACH message is associated with a RACH procedure of a user equipment (UE). In some aspects, the network entity 1602 may include means for transmitting, for the UE before a completion of the RACH procedure, a second RACH message that indicates an updated BWP. The means may be the component 199 of the network entity 1602 configured to perform the functions recited by the means. As described supra, the network entity 1602 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S ⊆ F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is an apparatus for wireless communication at a user equipment (UE), including: at least one memory; and at least one processor coupled to the at least one memory, based at least in part on information stored in the at least one memory, the at least one processor is configured to: transmit, to a network node, a first random access channel (RACH) message that indicates an update associated with an initial bandwidth part (BWP), where the first RACH message is associated with a RACH procedure; and receive, from the network node in response to the first RACH before a completion of the RACH procedure, a second RACH message that indicates an updated BWP.

Aspect 2 is the apparatus of aspect 1, where the second RACH message that indicates the updated BWP includes an indication of an early bandwidth adaptation, and where the second RACH message is before a radio resource control (RRC) reconfiguration.

Aspect 3 is the apparatus of aspect 2, where the early bandwidth adaptation and the update is based on a change of a set of bandwidth parameters associated with the initial BWP, and where the updated BWP is associated with an updated set of bandwidth parameters.

Aspect 4 is the apparatus of any of aspects 2-3, where the early bandwidth adaptation and the update is based on a change of a first candidate BWP associated with the initial BWP, and where the updated BWP is associated with a second candidate BWP.

Aspect 5 is the apparatus of any of aspects 2-4, where the early bandwidth adaptation and the update is based on a change of a first carrier or a first cell associated with the initial BWP, and where the updated BWP is associated with a second carrier or a second cell.

Aspect 6 is the apparatus of any of aspects 2-5, where the early bandwidth adaptation and the update is based on a change of a first carrier aggregation configuration or a first dual connectivity configuration associated with the initial BWP, and where the updated BWP is associated with a second carrier aggregation configuration or a second dual connectivity configuration.

Aspect 7 is the apparatus of any of aspects 2-6, where the indication of the early bandwidth adaptation is included in a random access response, a contention resolution message, or a message after contention resolution.

Aspect 8 is the apparatus of any of aspects 2-7, where the indication of the early bandwidth adaptation is associated with an action time where the updated BWP is effective, and where the action time is included in the second RACH message or a system information block (SIB).

Aspect 9 is the apparatus of any of aspects 1-8, where the first RACH message indicates the update based on an indicator regarding the update, a set of bandwidth parameters associated with the updated BWP, a link quality metric feedback, an operation parameter associated with the RACH procedure, or a traffic-related feedback, or where the first RACH message indicates the update based on a capability indication associated with the update that indicates at least one of: a maximum supported channel bandwidth, a bandwidth adaptation action time, a maximum rank, or a frequency hopping type associated with the UE.

Aspect 10 is the apparatus of any of aspects 1-9, where the first RACH message is a RACH preamble message with or without UE side medium access control (MAC) control element (MAC-CE), radio resource control (RRC) request message, or a beam failure recovery request message.

Aspect 11 is an apparatus for wireless communication at a network node, including: at least one memory; and at least one processor coupled to the at least one memory, based at least in part on information stored in the at least one memory, the at least one processor is configured to: receive a first random access channel (RACH) message that indicates an update associated with an initial bandwidth part (BWP), where the first RACH message is associated with a RACH procedure of a user equipment (UE); and transmit, for the UE before a completion of the RACH procedure, a second RACH message that indicates an updated BWP in response to the first RACH.

Aspect 12 is the apparatus of aspect 11, where the second RACH message that indicates the updated BWP includes an indication of an early bandwidth adaptation, and where the second RACH message is before a radio resource control (RRC) reconfiguration.

Aspect 13 is the apparatus of aspect 12, where the early bandwidth adaptation and the update is based on a change of a set of bandwidth parameters associated with the initial BWP, and where the updated BWP is associated with an updated set of bandwidth parameters.

Aspect 14 is the apparatus of any of aspects 12-13, where the early bandwidth adaptation and the update is based on a change of a first candidate BWP associated with the initial BWP, and where the updated BWP is associated with a second candidate BWP.

Aspect 15 is the apparatus of any of aspects 12-14, where the early bandwidth adaptation and the update is based on a change of a first carrier or a first cell associated with the initial BWP, and where the updated BWP is associated with a second carrier or a second cell.

Aspect 16 is the apparatus of any of aspects 12-15, where the early bandwidth adaptation and the update is based on a change of a first carrier aggregation configuration or a first dual connectivity configuration associated with the initial BWP, and where the updated BWP is associated with a second carrier aggregation configuration or a second dual connectivity configuration.

Aspect 17 is the apparatus of any of aspects 12-16, where the indication of the early bandwidth adaptation is included in a random access response, a contention resolution message, or a message after contention resolution.

Aspect 18 is the apparatus of any of aspects 12-17, where the indication of the early bandwidth adaptation is associated with an action time where the updated BWP is effective, and where the action time is included in the second RACH message or a system information block (SIB).

Aspect 19 is the apparatus of any of aspects 11-18, where the first RACH message indicates the update based on an indicator regarding the update, a set of bandwidth parameters associated with the updated BWP, a link quality metric feedback, an operation parameter associated with the RACH procedure, or a traffic-related feedback, or where the first RACH message indicates the update based on a capability indication associated with the update that indicates at least one of: a maximum supported channel bandwidth, a bandwidth adaptation action time, a maximum rank, or a frequency hopping type associated with the UE.

Aspect 20 is the apparatus of any of aspects 11-19, where the first RACH message is a RACH preamble message with or without UE side medium access control (MAC) control element (MAC-CE), radio resource control (RRC) request message, or a beam failure recovery request message.

Aspect 21 is a method of wireless communication for implementing any of aspects 1 to 10.

Aspect 22 is a computer-readable medium (e.g., a non-transitory computer-readable medium) storing computer executable code, the code when executed by at least one processor causes the at least one processor to implement any of aspects 1 to 10.

Aspect 23 is an apparatus comprising means for implementing any of aspects 1 to 10.

Aspect 24 is a method of wireless communication for implementing any of aspects 11 to 20.

Aspect 25 is a computer-readable medium (e.g., a non-transitory computer-readable medium) storing computer executable code, the code when executed by at least one processor causes the at least one processor to implement any of aspects 11 to 20.

Aspect 26 is an apparatus comprising means for implementing any of aspects 11 to 20.

What is claimed is:

1. An apparatus for wireless communication at a user equipment (UE), comprising:
at least one memory; and
at least one processor coupled to the at least one memory, based at least in part on information stored in the at least one memory, the at least one processor is configured to:
transmit, to a network node, a first random access channel (RACH) message that indicates an update associated with an initial bandwidth part (BWP), wherein the first RACH message is associated with a RACH procedure; and
receive, from the network node in response to the first RACH before a completion of the RACH procedure, a second RACH message that indicates an updated BWP.

2. The apparatus of claim 1, wherein the second RACH message that indicates the updated BWP comprises an indication of an early bandwidth adaptation, and wherein the second RACH message is before a radio resource control (RRC) reconfiguration.

3. The apparatus of claim 2, wherein the early bandwidth adaptation and the update is based on a change of a set of bandwidth parameters associated with the initial BWP, and wherein the updated BWP is associated with an updated set of bandwidth parameters.

4. The apparatus of claim 2, wherein the early bandwidth adaptation and the update is based on a change of a first candidate BWP associated with the initial BWP, and wherein the updated BWP is associated with a second candidate BWP.

5. The apparatus of claim 2, wherein the early bandwidth adaptation and the update is based on a change of a first carrier or a first cell associated with the initial BWP, and wherein the updated BWP is associated with a second carrier or a second cell.

6. The apparatus of claim 2, wherein the early bandwidth adaptation and the update is based on a change of a first carrier aggregation configuration or a first dual connectivity configuration associated with the initial BWP, and wherein the updated BWP is associated with a second carrier aggregation configuration or a second dual connectivity configuration.

7. The apparatus of claim 2, wherein the indication of the early bandwidth adaptation is included in a random access response, a contention resolution message, or a message after contention resolution.

8. The apparatus of claim 2, wherein the indication of the early bandwidth adaptation is associated with an action time where the updated BWP is effective, and wherein the action time is included in the second RACH message or a system information block (SIB).

9. The apparatus of claim 1,
wherein the first RACH message indicates the update based on an indicator regarding the update, a set of bandwidth parameters associated with the updated BWP, a link quality metric feedback, an operation parameter associated with the RACH procedure, or a traffic-related feedback, or
wherein the first RACH message indicates the update based on a capability indication associated with the update that indicates at least one of: a maximum supported channel bandwidth, a bandwidth adaptation action time, a maximum rank, or a frequency hopping type associated with the UE.

10. The apparatus of claim 1, wherein the first RACH message is a RACH preamble message with or without UE side medium access control (MAC) control element (MAC-CE), radio resource control (RRC) request message, or a beam failure recovery request message.

11. An apparatus for wireless communication at a network node, comprising:
at least one memory; and
at least one processor coupled to the at least one memory, based at least in part on information stored in the at least one memory, the at least one processor is configured to:
receive a first random access channel (RACH) message that indicates an update associated with an initial bandwidth part (BWP), wherein the first RACH message is associated with a RACH procedure of a user equipment (UE); and
transmit, for the UE before a completion of the RACH procedure, a second RACH message that indicates an updated BWP in response to the first RACH.

12. The apparatus of claim 11, wherein the second RACH message that indicates the updated BWP comprises an indication of an early bandwidth adaptation, and wherein the second RACH message is before a radio resource control (RRC) reconfiguration.

13. The apparatus of claim 12, wherein the early bandwidth adaptation and the update is based on a change of a set of bandwidth parameters associated with the initial BWP, and wherein the updated BWP is associated with an updated set of bandwidth parameters.

14. The apparatus of claim 12, wherein the early bandwidth adaptation and the update is based on a change of a first candidate BWP associated with the initial BWP, and wherein the updated BWP is associated with a second candidate BWP.

15. The apparatus of claim 12, wherein the early bandwidth adaptation and the update is based on a change of a first carrier or a first cell associated with the initial BWP, and wherein the updated BWP is associated with a second carrier or a second cell.

16. The apparatus of claim 12, wherein the early bandwidth adaptation and the update is based on a change of a first carrier aggregation configuration or a first dual connectivity configuration associated with the initial BWP, and wherein the updated BWP is associated with a second carrier aggregation configuration or a second dual connectivity configuration.

17. The apparatus of claim 12, wherein the indication of the early bandwidth adaptation is included in a random access response, a contention resolution message, or a message after contention resolution.

18. The apparatus of claim 12, wherein the indication of the early bandwidth adaptation is associated with an action time where the updated BWP is effective, and wherein the action time is included in the second RACH message or a system information block (SIB).

19. The apparatus of claim 11,
wherein the first RACH message indicates the update based on an indicator regarding the update, a set of bandwidth parameters associated with the updated BWP, a link quality metric feedback, an operation parameter associated with the RACH procedure, or a traffic-related feedback, or
wherein the first RACH message indicates the update based on a capability indication associated with the update that indicates at least one of: a maximum supported channel bandwidth, a bandwidth adaptation action time, a maximum rank, or a frequency hopping type associated with the UE.

20. A method for wireless communication performed by a user equipment (UE), comprising:
transmitting, to a network node, a first random access channel (RACH) message that indicates an update associated with an initial bandwidth part (BWP), wherein the first RACH message is associated with a RACH procedure; and
receiving, from the network node in response to the first RACH before a completion of the RACH procedure, a second RACH message that indicates an updated BWP.
